(19) United States
(12) Patent Application Publication
(10) Pub. No.: US 2008/0150999 A1
(43) Pub. Date: Jun. 26, 2008

(54) Imaging Apparatus Having Multi-Stage Printhead Wipers

(76) Inventors: Brian Dale Cook, Nicholasville, KY (US); Jeffrey Ray Ehlert, Lexington, KY (US); Robert Warren Rumford, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/614,442

(22) Filed: Dec. 21, 2006

(51) Int. Cl. B41J 2/165

(52) U.S. Cl. 347/33

(57) ABSTRACT

An imaging apparatus includes a printhead carrier having a first bay and a second bay. A first type of printhead cartridge is installed in the first bay. One of a second type of printhead cartridge and a third type of printhead cartridge is installed in the second bay. A drive mechanism is coupled to a wiper carrier to individually drive each of a first printhead wiper and a second printhead wiper between a non-wiping elevation and a wiping elevation. A controller is communicatively coupled to the drive mechanism, and selects one of the non-wiping elevation and the wiping elevation for the second printhead wiper depending on which of the second type of printhead cartridge and the third type of printhead cartridge is installed in the second bay.

### BACKGROUND OF THE INVENTION

1. Field of the Invention

The present invention relates to an imaging apparatus, and, more particularly, to an imaging apparatus having multi-stage printhead wipers.

2. Description of the Related Art

A printhead cartridge is formed as a single one-piece unit that includes an ink reservoir, a tape automated bond (TAB) circuit, and a printhead formed by a micro fluid ejection chip and ink jet nozzle plate arrangement. As is well known in the art, the printhead is in fluid communication with the ink reservoir. The micro fluid ejection chip (e.g., heater chip) of the printhead is electrically coupled to the TAB circuit. An encapsulant bead is formed around the printhead to seal around the ink jet nozzle plate at the outer surface of the TAB circuit.

An ink jet printer may produce prints using a monochrome (e.g., black) printhead cartridge and/or a color printhead cartridge. The monochrome printhead cartridge includes a single monochrome ink (e.g., black (K)). The color printhead cartridge may include three colors of full strength ink, typically cyan (C), magenta (M) and yellow (Y). The ink jet printer may also accommodate six-color photo printing by using a combination of the color printhead cartridge (CMY) with a photo printhead cartridge. The photo printhead cartridge includes, for example, a black ink (K), a dilute cyan ink (c) and a dilute magenta ink (m).

In some printing systems, the photo printhead cartridge may be used to replace the monochrome printhead cartridge to achieve the six-color photo printing. However, while the color printhead cartridge and the photo printhead cartridge may have the same printhead length, and in turn the same length of the encapsulant bead, the monochrome printhead cartridge may have a longer printhead length than the printhead length of the color printhead cartridge and the photo printhead cartridge, and in turn a longer encapsulant bead.

The ink jet printer typically includes a printhead maintenance system that includes a printhead wiper for wiping each of the printheads of the printhead cartridges installed in the ink jet printer before or after use to remove ink and particulate residue that may accumulate on or around the printhead(s). The contact of the printhead wiper with a printhead and its associated encapsulant bead over time results in wear to the wiping edge of the associated printhead wiper.

What is needed in the art is a printhead maintenance apparatus that can accommodate multiple printhead lengths without incurring uneven printhead wiper wear across a portion of the wiping edge length.

### SUMMARY OF THE INVENTION

The present invention provides a printhead maintenance apparatus that can accommodate multiple printhead lengths without incurring uneven printhead wiper wear across a portion of the wiping edge length.

The terms “first” and “second”, etc., preceding an element name, e.g., first printhead wiper, second printhead wiper, etc., are used for identification purposes to distinguish between similar elements, and are not intended to necessarily imply order, nor are the terms “first”, “second”, etc., intended to preclude the inclusion of additional similar elements.

The invention, in one form thereof, is directed to an imaging apparatus. The imaging apparatus includes a printhead carrier having a first bay and a second bay. A first type of printhead cartridge is installed in the first bay. The first type of printhead cartridge has a first printhead. One of a second type of printhead cartridge and a third type of printhead cartridge is installed in the second bay. The second type of printhead cartridge has a second printhead and the third type of printhead cartridge has a third printhead. A wiper carrier independently mounts a first printhead wiper having a first wiper edge length and a second printhead wiper having a second wiper edge length. The first wiper edge length is shorter than the second wiper edge length. A drive mechanism is coupled to the wiper carrier to individually drive each of the first printhead wiper and the second printhead wiper between a non-wiping elevation and a wiping elevation. A controller is communicatively coupled to the drive mechanism. The controller executes program instructions during a printhead wiping maintenance operation to select one of the non-wiping elevation and the wiping elevation for the second printhead wiper depending on which of the second type of printhead cartridge and the third type of printhead cartridge is installed in the second bay.

The invention, in another form thereof, is directed to a printhead maintenance apparatus, including a first printhead wiper having a first wiper edge length and a second printhead wiper having a second wiper edge length. The first wiper edge length is shorter than the second wiper edge length. A wiper carrier independently mounts the first printhead wiper and the second printhead wiper. A drive mechanism is coupled to the wiper carrier to individually drive each of the first printhead wiper and the second printhead wiper between a non-wiping elevation and a wiping elevation. The drive mechanism includes a motor having a drive shaft. A camshaft is drivably coupled to the drive shaft. The camshaft has a first cam having a first cam profile for linearly translating the first printhead wiper as the camshaft is rotated by the motor, and the camshaft has a second cam having a second cam profile for linearly translating the second printhead wiper as the camshaft is rotated by the motor.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a diagrammatic representation of an imaging system including an ink jet printer embodying the present invention.

FIG. 2 is a diagrammatic top view of a printhead maintenance apparatus in the ink jet printer of FIG. 1

FIG. 3 is a diagrammatic representation illustrating the relative lengths of the printheads, and the relative lengths of printhead wipers, of the ink jet printer of FIG. 1.

FIG. 4 is a graph illustrating the wiping and non-wiping elevations of the printhead wipers in relation to an angular rotation of a camshaft of the ink jet printer of FIG. 1, and graphically illustrating the cam profiles of the cams on the camshaft.

FIG. 5 is an end view of an exemplary camshaft relating to the graph of FIG. 4.

FIG. 6 is a flowchart of program steps executed by the controller of the ink jet printer of FIG. 1 that determine the relative vertical positions of the printhead wipers of the ink jet printer.

Corresponding reference characters indicate corresponding parts throughout the several views. The exemplifications set out herein illustrate one embodiment of the invention, in one form, and such exemplifications are not to be construed as limiting the scope of the invention in any manner.

### DETAILED DESCRIPTION OF THE INVENTION

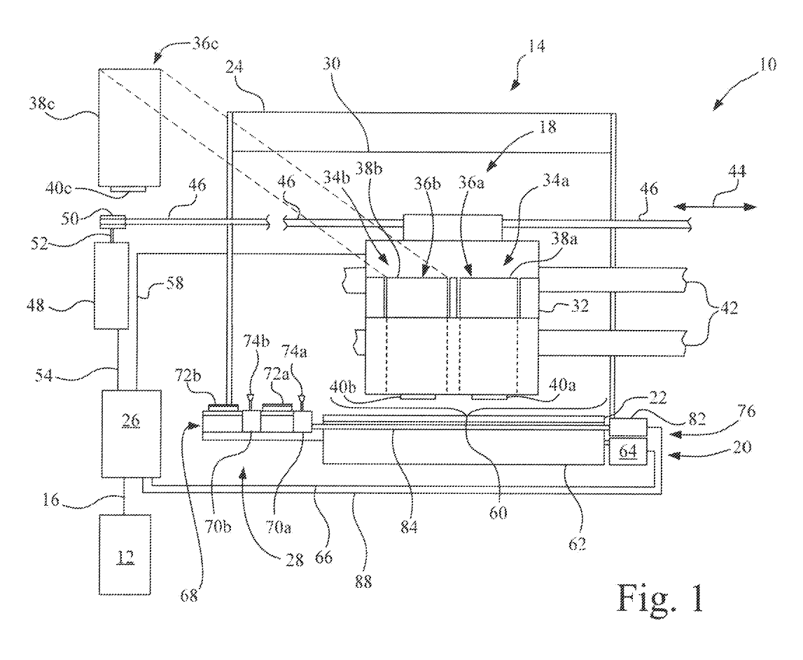

Referring now to the drawings and more particularly to FIG. 1, there is shown an imaging system 10 embodying the present invention. Imaging system 10 includes a computer 12 and an imaging apparatus in the form of an ink jet printer 14. Computer 12 is communicatively coupled to ink jet printer 14 by way of communications link 16. Communications link 16, for example, may be established by a direct cable connection, wireless connection or by a network connection such as for example an Ethernet local area network (LAN).

Computer 12 is typical of that known in the art, and includes a monitor to display graphics or text, an input device such as a keyboard and/or mouse, a microprocessor and associated memory, such as random access memory (RAM), read only memory (ROM) and a mass storage device, such as CD-ROM or DVD hardware. Resident in the memory of computer 12 is printer driver software. The printer driver software places print data and print commands in a format that can be recognized by ink jet printer 14.

Ink jet printer 14 includes a printhead carrier system 18, a feed roller unit 20, a mid-frame 22, a media source 24, a controller 26 and a printhead maintenance apparatus 28. In some embodiments, ink jet printer 14 may be incorporated into a multifunction machine, e.g., an all-in-one (AIO) unit, that further includes a scanner unit, and possibly a fax unit, that combine multiple functions, such as scanning, copying, and printing capabilities, in one device. Such a multifunction machine may be capable of operating in a standalone mode, without connection to computer 12.

Media source 24 is configured and arranged to supply from a stack of print media a sheet of print media 30 to feed roller unit 20, which in turn further transports the sheet of print media 30 during a printing operation.

Printhead carrier system 18 includes a printhead carrier 32 that defines a first bay 34a and a second bay 34b. A first type of printhead cartridge 36a, e.g., color, is installed in first bay 34a. One of a second type of printhead cartridge 36b, e.g., monochrome, and a photo printhead cartridge 36c, e.g., a photo printhead cartridge, is installed in second bay 34b.

Color printhead cartridge 36a includes a color ink reservoir 38a containing color ink, e.g., (CMY), which is provided in fluid communication with a color ink jet printhead 40a. Monochrome printhead cartridge 36b includes a monochrome ink reservoir 38b containing monochrome ink, e.g., black (K), which is provided in fluid communication with a monochrome ink jet printhead 40b. Photo printhead cartridge 36c includes a photo ink reservoir 38c containing photo ink, e.g., (Kcm), which is provided in fluid communication with a photo ink jet printhead 40c.

Printhead carrier 32 may be guided by a pair of guide members 42. Guide members 42 define a bi-directional scanning path 44 of printhead carrier 32. Printhead carrier 32 is connected to a carrier transport belt 46 that is driven by a carrier motor 48 via a carrier pulley 50. Carrier motor 48 may be, for example, a direct current motor or a stepper motor. Carrier motor 48 has a rotating motor shaft 52 that is attached to carrier pulley 50. Carrier motor 48 is electrically connected to controller 26 via a communications link 54. At a directive of controller 26, printhead carrier 32 is transported, via the rotation of carrier pulley 50 imparted by carrier motor 48, in a reciprocating manner, back and forth along bi-directional scanning path 44 as guided by guide members 42.

Ink jet printhead 40a and one of ink jet printheads 40b or 40c installed in second bay 34b, are electrically connected to controller 26 via a communications link 58. Communications link 58, for example, may be established by a direct cable connection. Controller 26 supplies electrical address and control signals to ink jet printer 14, and in particular, to the ink jetting actuators of ink jet printheads 40a, 40b or 40c to effect the selective ejection of ink from ink jet printheads 40a, 40b or 40c, both during a printing operation and during a spit maintenance operation.

During a printing operation, the reciprocation of printhead carrier 32 transports ink jet printheads 40a and 40b (or 40c) across the sheet of print media 30 along bi-directional scanning path 44, i.e. a scanning direction, to define a print zone 60 of ink jet printer 14. The sheet of print media 30 is transported through print zone 60 by the rotation of a feed roller 62 of feed roller unit 20. A rotation of feed roller 62 is effected by drive unit 64. Drive unit 64 is electrically connected to controller 26 via a communications link 66. Communications link 66, for example, may be established by a direct cable connection.

Printhead maintenance apparatus 28 is provided for performing printhead maintenance operations on the ink jet nozzles of ink jet printheads 40a, 40b and 40c. Such operations include, for example, a printhead spit maintenance operation and a printhead wiping operation. Other services, such as for example, a printhead maintenance capping operation, may also be performed by the inclusion of a capping device (not shown) of the type well known in the art.

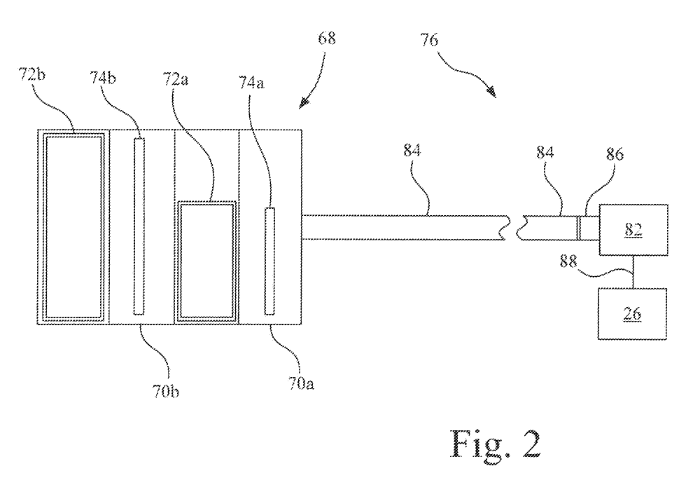

Referring also to FIG. 2, printhead maintenance apparatus 28 includes a wiper carrier 68 that independently mounts a first movable wiper unit 70a, a second movable wiper unit 70b, a first spit cup 72a, and a second spit cup 72b. During a printhead spit maintenance operation, ink may be ejected from one or more of printheads 40a, 40b or 40c, into a respective one of spit cups 72a, 72b.

Wiper unit 70a has mounted thereto a first printhead wiper 74a. Wiper unit 70b has mounted thereto a second printhead wiper 74b. Wiper carrier 68 independently mounts first printhead wiper 74a and second printhead wiper 74b via first movable wiper unit 70a and second movable wiper unit 70b, respectively, to facilitate individual movement, e.g., in a vertical direction, of first printhead wiper 74a and second printhead wiper 74b.

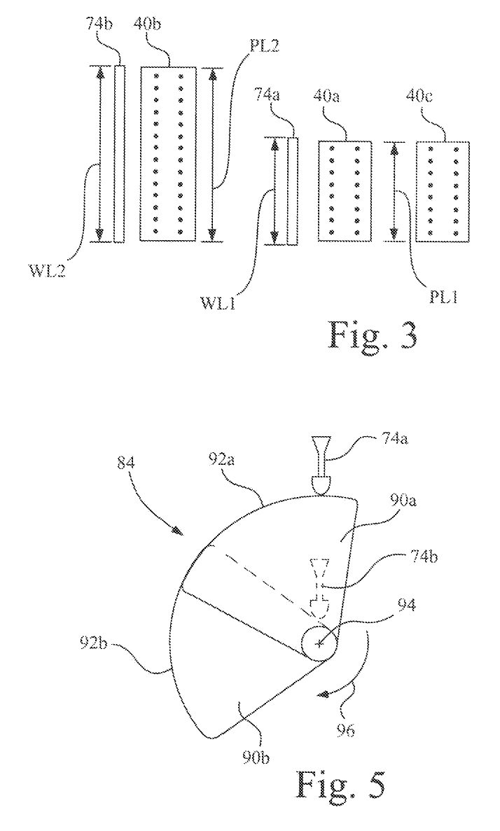

FIG. 3 is a diagrammatic representation of the relative lengths of printheads 40a, 40b and 40c, and the relative lengths of printhead wipers 74a and 74b.

The first type of printhead 40a may be, for example, a CMY color printhead having a first printhead length PL1. The second type of printhead 40b may be, for example, a K monochrome printhead having a second printhead length PL2. The third type of printhead 40c may be, for example, a Kcm photo printhead having the first printhead length PL1. As illustrated, the first printhead length PL1 is shorter than the second printhead length PL2.

One characteristic of first printhead wiper 74a is that it has a first wiper edge length WL1. One characteristic of second printhead wiper 74b is that it has a second wiper edge length WL2. As illustrated, the first wiper edge length WL1 is shorter than second wiper edge length WL2.

Also, as illustrated in FIG. 3, the first wiper edge length WL1 is selected to correspond generally to (being slightly longer than) the printhead length PL1 of the color and photo printheads 40a, 40c, and the second wiper edge length WL2 is selected to correspond generally to (being slightly longer than) the length of monochrome printhead 40b. It has been determined that the use of the relatively longer second (monochrome) printhead wiper 74b in wiping color and photo printheads 40a, 40c results in premature wear of a portion of the wiper edge length WL2 of second (monochrome) printhead wiper 74b corresponding to the first printhead length PL1, thereby resulting of inadequate wiping of monochrome printhead 40b by second (monochrome) printhead wiper 74b across the second wiper edge length WL2 due to the uneven wear. Thus, it is desirable to match the length of the printhead with the length of the printhead wiper during a wiping maintenance operation.

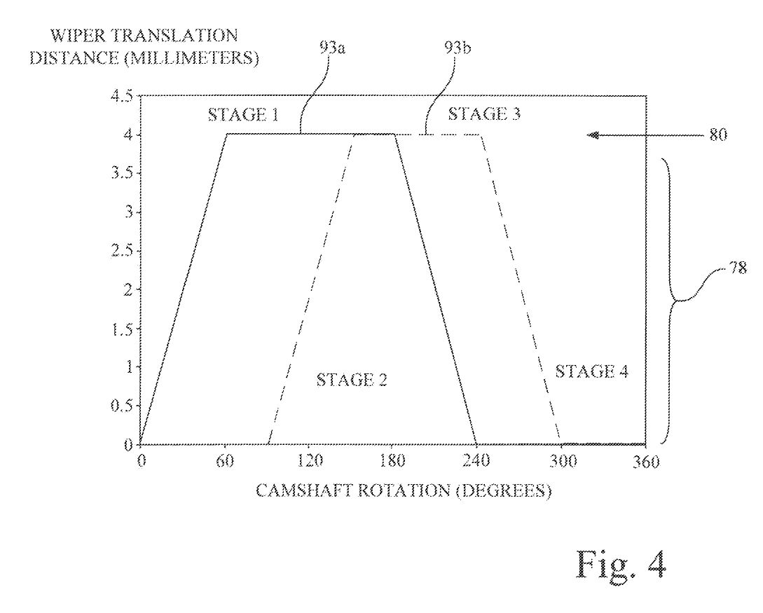

Referring again to FIG. 2, a drive mechanism 76 is coupled to wiper carrier 68 to individually drive each of first printhead wiper 74a and second printhead wiper 74b between a non-wiping elevation 78 and a wiping elevation 80. The non-wiping elevation 78 and wiping elevation 80 are illustrated in FIG. 4. Drive mechanism 76 includes a motor 82, such as a DC motor or stepper motor, and a camshaft 84. Motor 82 includes a drive shaft 86 mechanically coupled to camshaft 84, such as by a coupler sleeve, gear train, belt drive, etc. Controller 26 is communicatively coupled to drive mechanism 76, and more particularly to motor 82, via a communication link 88. Communications link 88, for example, may be established by a direct cable connection.

Referring also to FIG. 5, camshaft 84 includes a first cam 90a having a first cam profile 92a and a second cam 90b having a second cam profile 92b. The first cam 90a having first cam profile 92a is configured for linearly translating first printhead wiper 74a vertically, i.e., up and down, as camshaft 84 is rotated by motor 82 at the directive of controller 26, and second cam 90b having second cam profile 92b is configured for translating second printhead wiper 74b vertically, e.g., up and down, as camshaft 84 is rotated by motor 82. FIG. 4 includes a graphical depiction 93a of first cam profile 92a, and includes a graphical depiction 93b of second cam profile 92b. As shown in FIG. 5, and as graphically illustrated in FIG. 4, first cam profile 92a and second cam profile 92b may be substantially the same, but are angularly (rotationally) offset about an axis of rotation 94 in a direction of rotation 96. Those skilled in the art will recognize that the desired amount of angular rotational offset, and the amount and duration of lift defined by each of cams 90a, 90b, may be selected to achieve the desired vertical motion of printhead wiper 74a and printhead wiper 74b, as well as the timing and amount of angular duration per revolution (zero degrees through 360 degrees) of camshaft 84 that each of first printhead wiper 74a and second printhead wiper 74b is in one of non-wiping elevation 78 and wiping elevation 80.

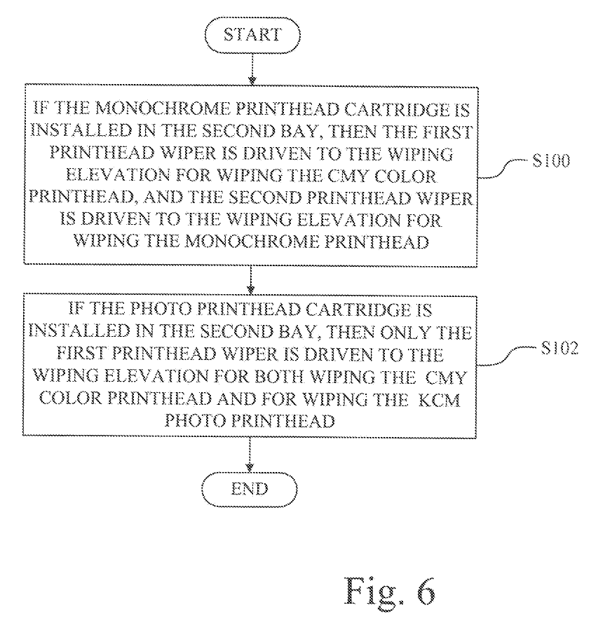

During a printhead wiping maintenance operation, controller 26 executes program instructions to control drive mechanism 76 to select the vertical position, i.e., one of non-wiping elevation 78 and wiping elevation 80, for each of first printhead wiper 74a and second printhead wiper 74b. The program instructions are represented by the general flowchart of FIG. 6.

At act S100, if the monochrome printhead cartridge 36b is installed in the second bay 34b, then first printhead wiper 74a is driven to wiping elevation 80 for wiping the CMY color printhead 40a, e.g., CMY color, and the second printhead wiper 74b is driven to the wiping elevation 80 for wiping the monochrome printhead 40b.

The determination of which of monochrome printhead cartridge 36b and photo printhead cartridge 36c is installed in the second bay 34b may be made, for example, from printhead cartridge type information received by controller 26. The source of the printhead cartridge type information may be, for example, a respective memory associated with each of monochrome printhead cartridge 36b and photo printhead cartridge 36c, or an identification input received from a user during cartridge installation.

At act S102, alternatively, if the photo printhead cartridge 36c is installed in the second bay 34b, then only the first printhead wiper 74a is driven to the wiping elevation 80 for both wiping the CMY color printhead 40a and for wiping the Kcm photo printhead 40c. The second printhead wiper 74 is at the non-wiping elevation 78. This orientation of first printhead wiper 74a and second printhead wiper 74b is depicted in FIG. 5. Thus, when performing printhead wiping maintenance during six-color printing, both the photo and color printheads 40a, 40c which are of substantially the same printhead length PL1 are wiped by a single printhead wiper 74a having a corresponding wiper edge length WL1 to ensure that unnecessary wiper wear at the interior of the relatively longer printhead wiper 74b having a wiper edge length WL2 does not occur.

Referring again to FIG. 3, four stages of travel for first printhead wiper 74a and second printhead wiper 74b are illustrated and described below in relation to FIGS. 2 and 5.

At the first stage (Stage 1,) the first printhead wiper 74a having a first wiper edge length WL1 is positioned at wiping elevation 80 and second printhead wiper 74b having a second wiper edge length WL2 is positioned at the non-wiping elevation 78. The first stage is selected by controller 26 for use so as to wipe both of the CMY color printhead 40a (color) and the Kcm photo printhead 40c (photo) with the first printhead wiper 74a when the color printhead cartridge 36a and the photo printhead cartridge 36c are installed in printhead carrier 32.

At the second stage (Stage 2), the first printhead wiper 74a having the first wiper edge length WL1 is positioned at the wiping elevation 80 and the second printhead wiper 74b having the second wiper edge length WL2 is positioned at the wiping elevation 80. The second stage is selected by controller 26 for use so as to wipe the CMY color printhead 40a with the first printhead wiper 74a and the monochrome printhead 40b with the second printhead wiper 74b when the color printhead cartridge 36a and the monochrome printhead cartridge 36b are installed in printhead carrier 32.

At the third stage (Stage 3), controller 26 controls drive mechanism 76 to position the first printhead wiper 74a having the first wiper edge length WL1 at the non-wiping elevation 78 and position the second printhead wiper 74b having the second wiper edge length WL2 at the wiping elevation 80.

At the fourth stage (Stage 4), i.e., during the start of a printing operation, controller 26 controls drive mechanism 76 to position both the first printhead wiper 74a at the non-wiping elevation 78 and the second printhead wiper 74b at the non-wiping elevation 78.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An imaging apparatus comprising:
a printhead carrier having a first bay and a second bay;
a first type of printhead cartridge installed in said first bay, said first type of printhead cartridge having a first printhead;
one of a second type of printhead cartridge and a third type of printhead cartridge installed in said second bay, said second type of printhead cartridge having a second printhead and said third type of printhead cartridge having a third printhead;
a wiper carrier independently mounting a first printhead wiper having a first wiper edge length and a second printhead wiper having a second wiper edge length, said first wiper edge length being shorter than said second wiper edge length;
a drive mechanism coupled to said wiper carrier to individually drive each of said first printhead wiper and said second printhead wiper between a non-wiping elevation and a wiping elevation; and
a controller communicatively coupled to said drive mechanism, said controller executing program instructions during a printhead wiping maintenance operation to select one of said non-wiping elevation and said wiping elevation for said second printhead wiper depending on which of the second type of printhead cartridge and said third type of printhead cartridge is installed in said second bay.

2. The imaging apparatus of claim 1, wherein said controller controls said drive mechanism to:
drive said first printhead wiper to said wiping elevation for wiping said first printhead, and drive said second printhead wiper to said wiping elevation for wiping said second printhead if said second type of printhead cartridge is installed in said second bay, and
drive only said first printhead wiper to said wiping elevation for wiping said first printhead and for wiping said third printhead if said third type of printhead cartridge is installed in said second bay.

3. The imaging apparatus of claim 2, wherein said first printhead is a color printhead having a first printhead length, said second printhead is a monochrome printhead having a second printhead length, and said third printhead is a photo printhead having said first printhead length, said first printhead length being shorter than said second printhead length.

4. The imaging apparatus of claim 1, wherein said drive mechanism includes:
a motor communicatively coupled to said controller, said motor having a drive shaft; and
a camshaft drivably coupled to said drive shaft, said camshaft having a first cam having a first cam profile for linearly translating said first printhead wiper as said camshaft is rotated by said motor, and said camshaft having a second cam having a second cam profile for linearly translating said second printhead wiper as said camshaft is rotated by said motor.

5. The imaging apparatus of claim 1, wherein a respective elevation of said first printhead wiper and said second printhead wiper is defined by a plurality of operating stages.

6. The imaging apparatus of claim 5, wherein each of said first printhead and said third printhead have a first printhead length, and said second printhead has a second printhead length different from said first printhead length, said plurality of stages including:
a first stage wherein said first printhead wiper having said first wiper edge length is positioned at said wiping elevation and said second printhead wiper having said second wiper edge length is positioned at said non-wiping elevation, said first stage being used for wiping both of said first printhead and said third printhead with said first printhead wiper when said first type of printhead cartridge and said third type of printhead cartridge are installed in said printhead carrier; and
a second stage wherein said first printhead wiper having said first wiper edge length is positioned at said wiping elevation and said second printhead wiper having said second wiper edge length is positioned at said wiping elevation, said second stage being used for wiping said first printhead with said first printhead wiper and for wiping said second printhead with said second printhead wiper when said first type of printhead cartridge and said second type of printhead cartridge are installed in said printhead carrier.

7. The imaging apparatus of claim 6, wherein said first printhead is a color printhead, said second printhead is a monochrome printhead, and said third printhead is a photo printhead.

8. The imaging apparatus of claim 6, said plurality of stages including:
a third stage wherein said first printhead wiper is positioned at said non-wiping elevation and said second printhead wiper is positioned at said wiping elevation; and
a fourth stage wherein said first printhead wiper is positioned at said non-wiping elevation and said second printhead wiper is positioned at said non-wiping elevation, said fourth stage being used during a printing operation.

9. A printhead maintenance apparatus, comprising:
a first printhead wiper having a first wiper edge length;
a second printhead wiper having a second wiper edge length, said first wiper edge length being shorter than said second wiper edge length;
a wiper carrier independently mounting said first printhead wiper and said second printhead wiper; and
a drive mechanism coupled to said wiper carrier to individually drive each of said first printhead wiper and said second printhead wiper between a non-wiping elevation and a wiping elevation, wherein said drive mechanism includes:
a motor having a drive shaft; and
a camshaft drivably coupled to said drive shaft, said camshaft having a first cam having a first cam profile for linearly translating said first printhead wiper as said camshaft is rotated by said motor, and said camshaft having a second cam having a second cam profile for linearly translating said second printhead wiper as said camshaft is rotated by said motor.

10. The printhead maintenance apparatus of claim 9, wherein said first cam and said second cam of said camshaft combine to define a plurality of operating stages of said first printhead wiper and said second printhead wiper.

11. The printhead maintenance apparatus of claim 10, wherein said plurality of stages include:
a first stage wherein said first printhead wiper having said first wiper edge length is positioned at a wiping elevation and said second printhead wiper having said second wiper edge length is positioned at a non-wiping elevation;
a second stage wherein said first printhead wiper having said first wiper edge length is positioned at said wiping elevation and said second printhead wiper having said second wiper edge length is positioned at said wiping elevation;
a third stage wherein said first printhead wiper having said first wiper edge length is positioned at said non-wiping elevation and said second printhead wiper having said second wiper edge length is positioned at said wiping elevation; and
a fourth stage wherein said first printhead wiper having said first wiper edge length is positioned at said non-wiping elevation and said second printhead wiper having said second wiper edge length is positioned at said non-wiping elevation.
